(19) United States
(12) Patent Application Publication
(10) Pub. No.: US 2021/0152042 A1
(43) Pub. Date: May 20, 2021

(54) ROTOR OF AN ELECTRICAL MACHINE WITH ASYMMETRIC MAGNETIC BRIDGES

(71) Applicant: IFP Energies nouvelles, Rueil-Malmaison (FR)

(72) Inventors: Thomas VALIN, RUEIL-MALMAISON (FR); Benjamin GAUSSENS, RUEIL-MALMAISON (FR); Baptiste CHAREYRON, RUEIL-MALMAISON (FR); Abdenour ABDELLI, RUEIL-MALMAISON (FR)

(21) Appl. No.: 17/263,100

(22) PCT Filed: Jul. 1, 2019
(86) PCT No.: PCT/EP2019/067566

§ 371 Date: Jan. 25, 2021

(30) Foreign Application Priority Data
Jul. 24, 2018 (FR) 18/56.865

(51) Int. Cl. H02K 1/27; H02K 1/24; H02K 19/02; H02K 21/02; H02K 21/14; H02K 29/03

(52) U.S. Cl. CPC H02K 1/2766; H02K 1/246; H02K 19/02; H02K 2213/03; H02K 21/14; H02K 29/03; H02K 21/028

(57) ABSTRACT

The present invention relates to a rotor (1) for an electric machine consisting of N primary magnetic poles (13) and N secondary magnetic poles (14), said poles consisting themselves of flux barriers (9, 10, 11) separated from axial housings (6) by magnetic bridges (19, 20, 21). According to the invention, on either side of axial housings (6), magnetic bridges (19, 20, 21) are aligned in a straight line, forming an angle α1 for primary magnetic poles (13) and an angle α2 for secondary magnetic poles (14) with respect to a radial direction, in such a way that α2=α1+1±0.5.

The invention further relates to an electric machine comprising such a rotor.

### CROSS-REFERENCE TO RELATED APPLICATIONS

This application is a National Stage Application of PCT/EP2019/067566, filed Jul. 1, 2019, which claims priority to French Patent Application No. 18/56.865, filed Jul. 24, 2018, the contents of each of which are incorporated herein by reference in their entirety.

### BACKGROUND OF THE INVENTION

### Field of the Invention

The present invention relates to a synchro-reluctant (permanent magnet-assisted) rotary electrical machine and it more particularly concerns a rotor of such an electrical machine operating at a high rotational speed with a low-voltage continuous bus.

### Description to the Prior Art

Generally, such an electrical machine comprises a stator and a rotor coaxially arranged in one another.

The rotor is a stack of metal sheets arranged on a rotor shaft. These sheets include housings for permanent magnets, and perforations for creating flux barriers allowing the magnetic flux of the magnets to be radially directed towards the stator and for promoting the generation of a reluctance torque.

This rotor is generally housed within a stator that carries electrical windings allowing generation of a magnetic field enabling the rotor to be driven in rotation.

### Background of the Invention

As is better described in patent application WO-2016/188,764, the rotor comprises a plurality of axial recesses running throughout the sheets.

A first series of axial recesses, radially arranged one above the other and at a distance from one another, forms housings for magnetic flux generators, which here are permanent magnets formed from rectangular bars.

The other series of recesses has perforations of inclined radial direction, starting from the housings and ending in the vicinity of the edge of the sheets.

The inclined perforations are arranged symmetrically with respect to the magnet housings to form each time a substantially V-shaped flat-bottomed geometrical figure, which is formed by the magnet housing and the inclined arms of the V being formed by the perforations. Flux barriers formed by the perforations are thus created. The magnetic flux from the magnets then cannot but transit through the solid parts between the perforations.

These solid parts are made of a ferromagnetic material. For this rotor configuration, the material thickness between the permanent magnet housings and the flux barriers is referred to as magnetic bridge.

These magnetic bridges are generally thin and they must withstand high mechanical stresses (break, fatigue), which increase notably with the rotational speed of the rotor.

Patent application EP-2,896,114 solves this problem through a specific orientation of the magnetic bridges. However, the proposed geometry notably generates torque ripples and counter-electromotive force harmonics.

Indeed, it has been observed that the counter-electromotive force harmonics and the torque ripples are significant in this type of permanent magnet-assisted synchronous reluctance machine.

This may generate jolts and vibrations at the rotor, thus causing discomfort in using this machine.

### SUMMARY OF THE INVENTION

The present invention addresses these aforementioned drawbacks, and notably reduces the mechanical fatigue and breaking stresses undergone by the rotor, while limiting the torque ripple, the counter-electromotive force harmonics and the acoustical noise.

The present invention relates to a rotor for an electrical machine, the rotor comprising:
a rotor body, made up of a stack of metal sheets, preferably arranged on a rotor shaft,
N pairs of magnetic poles, each magnetic pole having at least three magnets positioned in axial recesses; and
three flux barriers which make up each magnetic pole include an external flux barrier, a central flux barrier and an internal flux barrier. Each flux barrier comprises two inclined recesses positioned on either side of each axial recess, and are spaced out from the axial recess by a magnetic bridge.

The rotor further comprises:
N primary magnetic poles and, for each primary magnetic pole, on either side of the axial recess, the internal, central and external magnetic bridges are aligned along an axis Δ1 forming an angle α1 with respect to the radial direction R1 of the primary magnetic pole;
N secondary magnetic poles and, for each secondary magnetic pole, on either side of the axial recess, the internal, central and external magnetic bridges are aligned along an axis Δ2 forming an angle α2 with respect to the radial direction R2 of the secondary magnetic pole; and
in such a way that angles α1 and α2 are verified by the equation, expressed in degrees: α2=α1+1±0.5.

According to an embodiment of the invention, the number N of pole pairs ranges between 2 and 9, preferably between 3 and 6, and it is more preferably 4.

Advantageously, the number N of pole pairs is 4, angle α2 ranges between 16.1° and 16.2°, and angle α1 ranges between 14.6° and 14.7°.

According to an implementation, the flux barriers are substantially V-shaped with a flat bottom.

According to an aspect, the thickness of the internal magnetic bridge is greater than or equal to the thickness of the central magnetic bridge, which is greater than or equal to the thickness of the external magnetic bridge.

According to a characteristic, the opening angles θ1, θ2, θ3 of the flux barriers of the primary magnetic poles are greater than the opening angles θ1, θ2, θ3 of the flux barriers of the secondary magnetic poles.

The invention further relates to an electrical machine comprising a stator and a rotor according to any one of the above characteristics with the rotor being housed inside the stator.

According to an embodiment, the stator comprises radial slots circumferentially arranged along the stator.

According to an implementation, the slots extend axially along the stator.

Advantageously, the electrical machine is of synchro-reluctant type.

### BRIEF DESCRIPTION OF THE FIGURES

Other features and advantages of a device according to the invention will be clear from reading the description hereafter of embodiments, given by way of non-limitative example, with reference to the accompanying figures wherein:

FIG. 1 illustrates a rotor according to an embodiment of the invention;

FIG. 2 illustrates an electrical machine according to an embodiment of the invention; and

FIG. 3 illustrates a rotor according to another embodiment of the invention;

FIG. 4 illustrates a housing for a magnet of a rotor according to an embodiment of the invention,

FIG. 5 is a histogram representing the von Mises criterion for four areas defined in FIG. 4, for a rotor according to the prior art and for a rotor according to the invention; and

FIG. 6 shows mechanical stress (break and fatigue) curves as a function of an angular shift of the angles of the magnetic bridges.

### DETAILED DESCRIPTION OF THE INVENTION

The present invention relates to a rotor for an electrical machine, which is notably an electrical machine of synchro-reluctant type. Furthermore, the present invention relates to an electrical machine comprising a rotor according to the invention and a stator with the rotor being arranged inside the stator and coaxially thereto.

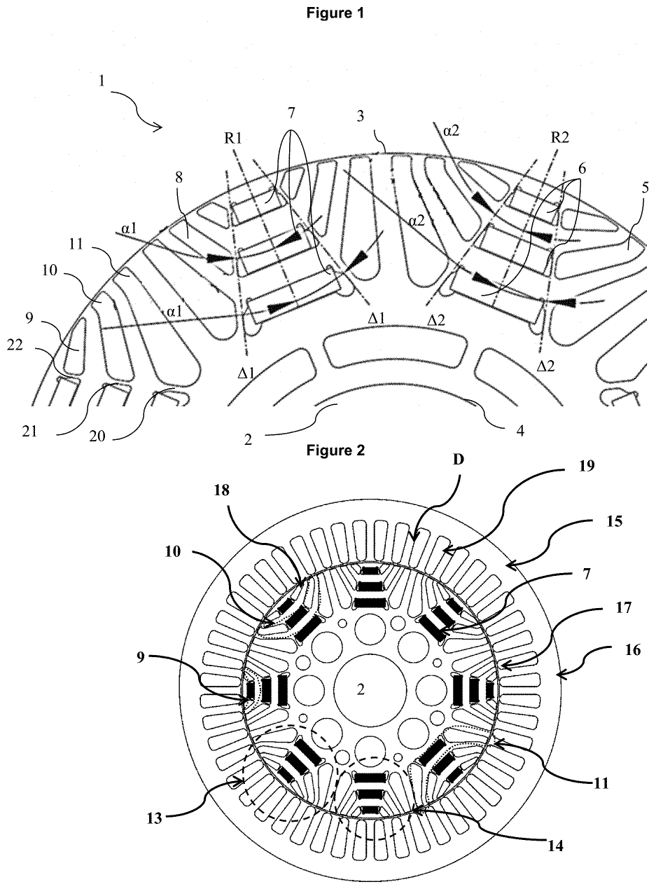

As illustrated in FIG. 1 (by way of non-limitative example), a rotor 1 comprises, in a manner known per se, a shaft 2, which is preferably magnetic, on which a stack of metal sheets 3 is arranged. Within the context of the invention, these sheets 3 are ferromagnetic, flat, identical, rolled and of circular shape, and are assembled to one another by any known means. Sheets 3 can comprise a central bore 4 traversed by rotor shaft 2 and axial recesses 5 running throughout sheets 3.

A first series of axial recesses 6, radially arranged above one another and at a distance from one another, form housings for magnetic flux generators, here permanent magnets 7 which are bars. Axial recesses 6 substantially form trapezia. However, axial recesses 6 can have other shapes, notably rectangular, square, etc.

A second series of recesses are perforations 8 of inclined direction with respect to the radial direction, starting from axial recesses 6 and ending in the vicinity of the edge of sheets 3, in the region of an air gap of the electrical machine.

Inclined perforations 8 are arranged symmetrically with respect to recesses 6 of magnets 7 which form each time a substantially V-shaped flat-bottomed geometrical figure. The flat bottom is formed by housing 6 of magnets 7 and the inclined arms of the V are formed by which. Inclined perforations 8 form flux barriers. The magnetic flux from magnets 7 then can only transit through the solid parts of sheets 3 between the recesses. These solid parts are made of a ferromagnetic material (which sheets 3 are made of).

According to the invention, the rotor comprises N pairs of magnetic poles (or 2×N magnetic poles). A magnetic pole has three recesses 6 for the magnets in the same radial direction, and the associated flux barriers (9, 10, 11). Advantageously, N can range between 2 and 9, preferably N ranges between 3 and 6, and it is more preferably equal to 4.

For the example illustrated in FIGS. 1 and 2, rotor 1 comprises eight magnetic poles (N=4). Each magnetic pole has three permanent magnets 7 positioned in the three axial recesses 6 provided for housing permanent magnets 7. Rotor 1 is also made up of three flux barriers, including an external flux barrier 9 (associated with external recess 6, that is closest to the periphery of rotor, a central flux barrier 10 that is associated with central recess 6 and an internal flux barrier 11 that is associated with internal recess 6, closest to the center of rotor 1.

Each flux barrier (9, 10, 11) is spaced out from an axial recess 6 by a magnetic bridge (20, 21, 22). The magnetic bridge (20, 21, 22) is a material bridge (which is a portion of the material of sheet 3 between two recesses and which provides on the one hand mechanical strength of rotor 1 and, on the other hand passage of the magnetic flux. A magnetic bridge (20, 21, 22) is thus provided on either side of each axial recess 6. Each magnetic pole then comprises two internal magnetic bridges 20 (associated with internal axial recess 6, closest to the center of the rotor, and with internal magnetic flux barrier 11, two central magnetic bridges 21 (associated with central axial recess 6 and with central magnetic flux barrier 10), and two external magnetic bridges 22 associated with external axial recess 6, which is closest to the periphery of the rotor and to external magnetic flux barrier 9.

Within the context of the invention, rotor 1 comprises two distinct magnetic pole architectures. It therefore comprises N primary magnetic poles 13 and N secondary magnetic poles 14. The rotor comprises an alternation of primary magnetic poles 13 and secondary magnetic poles 14. For the examples of FIGS. 1 and 2, rotor 1 comprises four primary magnetic poles 13 and four secondary magnetic poles 14.

According to the invention, for each primary magnetic pole 13, on either side of axial recesses 6, the internal 20, central 21 and external 22 magnetic bridges are aligned along an axis Δ1 forming a non-zero angle α1 with respect to the radial direction R1 of primary magnetic pole 13.

Furthermore, for each secondary magnetic pole 14, on either side of axial recesses 6, the internal 20, central 21 and external 22 magnetic bridges are aligned along an axis Δ2 forming a non-zero angle α2 with respect to the radial direction R2 of secondary magnetic pole 14.

Moreover, angles α1 and α2 are selected to verify the following equality: α2=α1+1±0.5. In the present application, X+/−Y (with X and Y positive numbers) means an interval centered on value X, the interval ranging between the values X-Y and X+Y, endpoints included.

Advantageously, angles α1 and α2 can range between 10° and 20°.

In other words, magnetic bridges (20, 21, 22) on either side of axial recesses 6 are positioned on straight lines Δ1 or Δ2, with lines Δ1 or Δ2 being secant with radii R1 or R2 of the rotor to form distinct angles α1 or α2. Preferably, lines Δ1 or Δ2 pass through the lateral ends of axial recesses 6. Advantageously, each magnetic pole has a symmetrical architecture with respect to the radial direction R1 or R2 of the pole. In other words, flux barriers (9, 10, 11) and magnetic bridges (20, 21, 22) are symmetrical with respect to radial direction R1 or R2. Thus, angle α1 or α2 on one side of the magnetic pole is identical to angle α1 or α2 on the other side of the same magnetic pole.

This configuration provides, on the one hand, a dissymmetry of the primary magnetic poles and of the secondary magnetic poles, and on the other hand it enables guarantee of good mechanical breaking and fatigue strength of the rotor, even at high rotational speeds, through homogenization of the stresses in the material.

For the non-limitative embodiment of FIGS. 1 and 2, where N=4, angle α2 can range between 16.1° and 16.2°, and angle α1 can range between 14.6° and 14.7°. Preferably, the value of angle α2 can be 16.15° and the value of angle α1 can be 14.65°.

According to an implementation of the invention, the thickness of internal magnetic bridge 20 is greater than or equal to the thickness of central magnetic bridge 21, which is greater than or equal to the thickness of external magnetic bridge 22. This configuration provides good mechanical strength of the rotor. Indeed, the stresses are higher at internal magnetic bridge 20 than at external magnetic bridge 22.

Advantageously, the magnetic bridge thicknesses can range between 0.65 mm and 1 mm to satisfy the mechanical stresses.

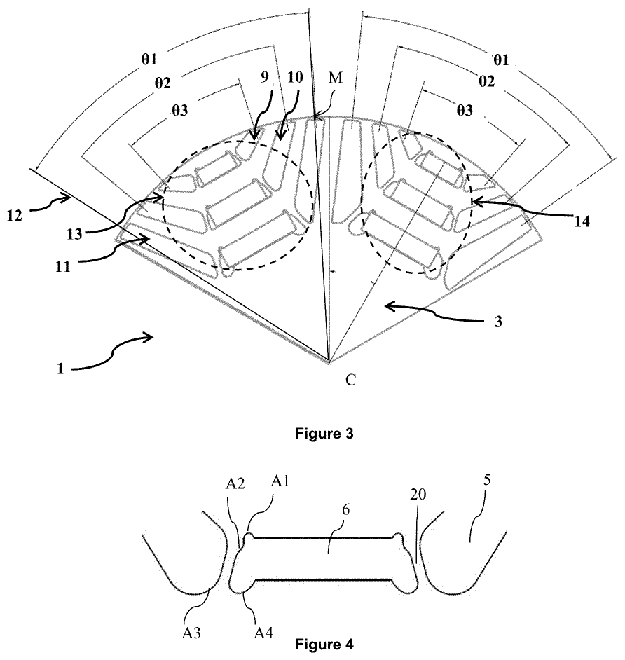

FIG. 3 schematically illustrates, by way of non-limitative example, a portion of a rotor 1 with three pole pairs (N=3) according to an embodiment of the invention.

An opening angle (01, 02, 03) that qualifies the opening of the V shape corresponds to each flux barrier (9, 10, 11) of each magnetic pole. These opening angles correspond to the angle between two straight lines (Δ1, Δ2) each passing through the center C of rotor 1 and through a midpoint M positioned at an outer face 12 of the perforations 8 of inclined radial direction of each flux barrier. This outer face 12 is on the periphery of rotor 1, in the region of a mechanical air gap of the electrical machine, as detailed in the description hereafter.

According to an embodiment of the invention, opening angles (θ1, θ2, θ3) of flux barriers (9, 10, 11) of primary magnetic poles 13 can be greater than opening angles (θ1, θ2, θ3) of flux barriers (9, 10, 11) of secondary magnetic poles 14. Thus, the architecture of secondary magnetic poles 14 is different from the architecture of primary magnetic poles 13. Opening angles (θ1, θ2, θ3) can then be selected to minimize the torque ripples, the counter-electromotive force harmonics and the acoustic noise. Indeed, asymmetrical flux barriers are thus created between two consecutive poles. The magnetic flux from the magnets then cannot but transit through the solid parts between the perforations and it allows reduction of the torque ripple, the counter-electromotive force harmonics and the acoustic noise.

This embodiment is particularly well suited for the invention. Indeed, the angles of the magnetic bridges and the opening angles of the flux barriers are thus different between a primary magnetic pole and a secondary magnetic pole. It is thereby possible to limit the mechanical stresses in the rotor while limiting torque ripples.

As can be seen in FIG. 2, which schematically illustrates, by way of non-limitative example, a rotary electrical machine according to an embodiment of the invention (here a permanent magnet-assisted variable-reluctance synchronous machine), the electrical machine also comprises a stator 15 coaxially engaged around rotor 1.

Stator 15 comprises an annular ring 16 with an inner wall 17 whose inside diameter is designed to receive rotor 1 with a space necessary for providing an air gap 18. This ring comprises a multiplicity of slots (bores), of oblong section here, forming slots 19 for the armature windings.

More precisely, these bores extend axially all along stator 15 while being radially arranged on the ring and circumferentially at a distance from one another, by a distance D. The number of slots is predetermined as a function of the characteristics of the electrical machine and as a function of the number N of pole pairs. For the example illustrated in FIG. 2, where the number N of pole pairs is 4, there are 48 slots.

According to an example embodiment, the outside diameter of the stator can range between 100 and 300 mm, and it is preferably around 140 mm, and the inside diameter can range between 50 and 200 mm, preferably around 95 mm. The length of air gap 18 of the electrical machine can range between 0.4 and 0.8 mm, preferably between 0.5 and 0.6 mm.

It is obvious that the invention is not limited to the recess shapes described above by way of example, and that it encompasses any variant embodiment.

FIG. 4 schematically illustrates, by way of non-limitative example, a housing for a magnet of a rotor according to an embodiment of the invention. It can be an internal axial recess 6. This axial recess 6, designed to receive a magnet, has a substantially trapezoidal general shape, with various fillets at the four corners thereof. The fillets can be so selected as to optimize the mechanical stresses in the metal sheet. However, the axial recess may have other shapes and/or other fillets. Two inclined perforations 5 forming the flux barriers are provided on either side of axial recess 6. Two magnetic bridges 20 are provided between axial recess 6 and inclined perforations 5.

This FIG. 4 also shows four areas A1, A2, A3 and A4 which are areas in the metal sheets of rotor 1 between axial recess 6 and inclined perforations 5.

For these four areas A1 to A4, a von Mises stress criterion has been calculated for an electrical machine according to the prior art with symmetrical magnetic bridges between the poles (α1=α2) and for an electrical machine according to the invention with asymmetrical magnetic bridges between the poles, in particular according to the configuration of FIG. 1 with α1=14.65° and α2=16.15°. The two electrical machines thus compared are identical, except for angles α1 and α2.

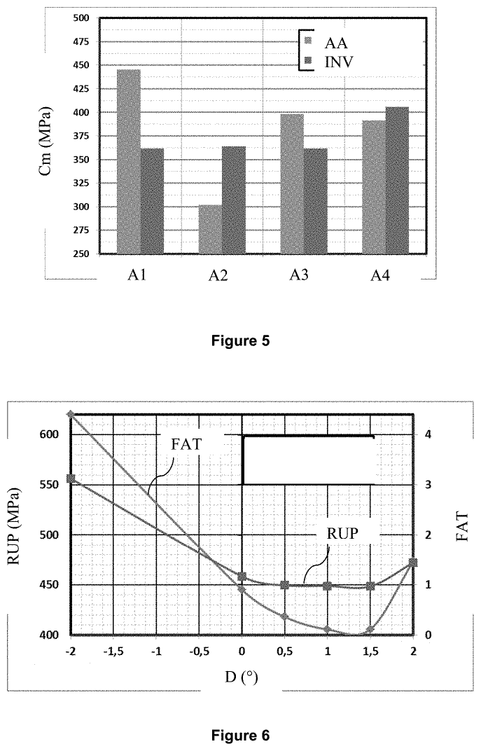

FIG. 5 is a histogram illustrating the comparison of this von Mises stress criterion Cm in MPa between the electrical machine according to the prior art AA and the electrical machine according to the invention INV, for the four areas A1 to A4 defined in FIG. 4. Thus, it appears that the magnetic bridges as defined according to the invention allow the stresses in the material to be homogenized. Furthermore, it can be noted that the maximum stress according to this criterion is greater for the prior art (445 MPa) than for the invention (406 MPa).

FIG. 6 shows a curve representative of the mechanical breaking stress RUP in MPa (obtained according to the von Mises criterion) and a curve representative of the mechanical fatigue stress FAT (unitless and obtained according to the Haigh and Goodman criterion) as a function of the angular shift D in degrees (°) between angles α1 and α2 (D=α2−α1), for a rotor of an electrical machine according to the embodiment of FIG. 1. It appears that an angular shift ranging between 0.5° and 1.5° allows reducing both the mechanical breaking stresses and the mechanical fatigue stresses on the rotor. Therefore, the invention that defines a relation between the angles, α2=α1+1±0.5, indeed allows the mechanical breaking and fatigue stresses on the rotor to be reduced, in particular in relation to a rotor where all the magnetic bridges would be identical for the primary magnetic poles and the secondary magnetic poles (D=0 because α11=α2).

Thus, the rotor according to the invention is suited for a synchro-reluctant electrical machine operating with a low-voltage continuous bus allowing a high rotational speed (above 15,000 rpm).

1.-10. (canceled)

11. A rotor for an electrical machine, the rotor comprising:
a rotor body, including a stack of metal sheets, arranged on a rotor shaft,
N pairs of magnetic poles, each magnetic pole including at least three magnets positioned in axial recesses; and
the three flux barriers of each magnetic pole, include an external flux barrier, a central flux barrier and an internal flux barrier, each flux barrier comprising two inclined recesses positioned on either side of each axial recess, each flux barrier being spaced out from the axial recess by a magnetic bridge; wherein
the rotor comprises:
N primary magnetic poles and, for each primary magnetic pole, on either side of the axial recess, the internal, central and external magnetic bridges are aligned along an axis 41 forming an angle α1 with respect to the radial direction R1 of the primary magnetic pole;
N secondary magnetic poles and, for each secondary magnetic pole, on either side of the axial recess, the internal, central and external magnetic bridges are aligned along an axis 42 forming an angle α2 with respect to the radial direction R2 of the secondary magnetic pole; and
angles α1 and α2 verify an equation, expressed in degrees: α2=α1+1±0.25.

12. A rotor as claimed in claim 10, wherein the number N of pole pairs ranges between 2 and 9.

13. A rotor as claimed in claim 11, wherein the number N of pole pairs is 4, angle α2 ranges between 16.1° and 16.2°, and angle α1 ranges between 14.6° and 14.7°.

14. A rotor as claimed in claim 11, wherein the flux barriers are V-shaped with a flat bottom.

15. A rotor as claimed in claim 11, wherein a thickness of the internal magnetic bridge is greater than or equal to a thickness of the central magnetic bridge, which is greater than or equal to a thickness of the external magnetic bridge.

16. A rotor as claimed in claim 11, wherein opening angles θ1, θ2, θ3 of the flux barriers of the primary magnetic poles are greater than opening angles θ1, θ2, θ3 of the flux barriers of the secondary magnetic poles.

17. An electrical machine as claimed in claim 10 comprising a stator and a rotor, the rotor being housed inside the stator.

18. An electrical machine as claimed in claim 17, wherein the stator comprises radial slots circumferentially arranged along the stator.

19. An electrical machine as claimed in claim 18, wherein the slots extend axially along the stator.

20. An electrical machine as claimed claim 17, wherein the electrical machine is of synchro-reluctant machine.

21. A rotor as claimed in claim 12 wherein the number of poles is between 3 and 6.

22. A rotor as claimed in claim 12 wherein the number of pole pairs is 4.
